(19) United States
(12) Patent Application Publication
(10) Pub. No.: US 2026/0080174 A1
(43) Pub. Date: Mar. 19, 2026

(54) CASCADING RULES FOR CROSS-CHANNEL EVENT STITCHING USING IDENTITY GRAPHS

(71) Applicant: Adobe Inc., San Jose, CA (US)

(72) Inventors: Victor GRIGORIU, Bucharest (RO); Razvan Catalin BURLACIOIU, Brasov (RO); Matthew McKay THOMAS, Rexburg, ID (US); Madalina Georgiana CIOLACU, Brasov (RO); Ionel Alexandru IVANA, Bucuresti (RO); Cristina BUCIU, Bucharest (RO)

(21) Appl. No.: 18/889,973

(22) Filed: Sep. 19, 2024

(30) Foreign Application Priority Data
Sep. 16, 2024 (RO) A/10059/2024
Sep. 16, 2024 (RO) A/10060/2024

(51) Int. Cl. G06F 40/295; G06F 16/335

(52) U.S. Cl. CPC G06F 40/295; G06F 16/337

(57) ABSTRACT

Methods and systems are provided for cascading rules for cross-channel event stitching using identity graphs. In embodiments described herein, event record datasets from different communication channels are accessed and identity graphs are generated based on the event record datasets. Detected identity values for a selected priority of common identity namespaces are determined based on a graph lookup of the identity graphs using a selected priority of graph lookup identity namespaces for each event record dataset of the event record datasets and the selected priority of common identity namespaces. The event record datasets from different communication channels are appended to include the detected identity values. Performance metrics can then be generated across the different communication channels based on event data and the detected identity values of the event records.

### CROSS REFERENCE TO RELATED APPLICATIONS

This application claims the benefit of priority to Romanian Patent Application No. A/10059/2024 filed on Sep. 16, 2024, and Romanian Patent Application No. A/10060/2024 filed on Sep. 16, 2024, each of which are incorporated by reference herein in their entirety.

### BACKGROUND

Businesses collect and analyze customer data to gain insights into customer behavior by gathering data from various sources and analyzing the customer data to optimize marketing strategies. However, as businesses often collect different customer data to identify the customer from different communication channels, the customer data from the various communication channels often cannot be combined. Further, an individual customer will often utilize multiple devices to engage with the business through the different communication channels and the business cannot combine the customer data across the different devices for the individual customer. As such, the customer data remains fragmented across the various communication channels and devices.

### SUMMARY

Various aspects of the technology described herein are generally directed to systems, methods, and computer storage media for, among other things, cross-channel event stitching using identity graphs. In this regard, embodiments described herein facilitate using identity graphs to append event records of event record datasets from different communication channels to include a common identity namespace in order to generate performance metrics and/or personalize customer experiences across the different communication channels. For example, event records regarding interactions with users are collected from various communication channels, such as web applications, mobile applications, email, SMS, social media platforms, call centers and/or other communication channels, or combinations thereof, via a corresponding event collection component for each communication channel. The event records of the event record datasets from the various communication channels and/or profile record datasets are used to generate identity graphs for the users. An identity namespace is selected to be used as the graph lookup identity namespace for the event record datasets from the different communication channels. A different identity namespace that may not be available in some of the event record datasets is selected to be used as the common identity namespace to be used across the event record datasets from the different communication channels. The identity value of the selected graph lookup identity namespace is then determined for each event record of the event record datasets from the different communication channels. A graph lookup is then performed on the identity graphs using the determined identity values of the selected graph lookup identity namespace for each event record of the event record datasets from the different communication channels to determine the corresponding identity value of the selected common identity namespace for each event record. Each event record of the event record datasets from the different communication channels are appended to include the corresponding determined identity value of the selected common identity namespace for the corresponding event. As each of the event records from the different communication channels are appended to include a common identity, the event records can be utilized to generate performance metrics and/or personalize customer experiences across the different communication channels.

In some embodiments, a set of identity namespaces are selected as the potential graph lookup identity namespace and priority values are assigned to each identity namespace of the set of potential graph lookup identity namespaces. The identity value of the graph lookup identity namespace for each event record of the event record datasets from the different communication channels is then determined based on the availability of the identity value of the graph lookup identity namespace with the highest priority in each event record. Further, a set of identity namespaces are selected as the potential common identity namespace, and priority values are assigned to each identity namespace of the set of potential common identity namespaces. The identity value of the common identity namespace for each event record of the event record datasets from the different communication channels is then determined based on the availability of the identity value of the common identity namespace with the highest priority in each identity graph. In this regard, the selected priority of graph lookup identity namespaces and/or the selected priority of common identity namespaces can be applied to all of the event record datasets of the different communication channels even when different identity namespaces are collected through the different communication channels.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIG. 3A provides an example diagram of cross-channel event stitching, in accordance with embodiments of the present disclosure.

FIG. 3B provides an example diagram of example event record datasets and example identity graphs for cross-channel event stitching using identity graphs, in accordance with embodiments of the present disclosure.

FIG. 4A provides an example diagram of cross-channel event stitching using the example event record datasets and the example identity graphs of FIG. 3B, in accordance with embodiments of the present disclosure.

FIG. 4B provides another example diagram of cross-channel event stitching using the example event record datasets and the example identity graphs of FIG. 3B, in accordance with embodiments of the present disclosure.

FIG. 5A provides an example diagram of using cascading rules for cross-channel event stitching using the example event record datasets and the example identity graphs of FIG. 3B, in accordance with embodiments of the present disclosure.

FIG. 5B provides an example diagram indicating the increase in a common identity value for event records from event record datasets from different communication channels following cross-channel event stitching, in accordance with embodiments of the present disclosure.

FIG. 5C provides an example table indicating the increase in coverage of the common identity namespace, in certain scenarios, when using cascading rules for cross-channel event stitching compared to using a single graph lookup identity namespace and a single common identity namespace, in accordance with embodiments of the present disclosure.

FIG. 6 is a process flow showing a method for cross-channel event stitching using identity graphs, in accordance with embodiments of the present disclosure.

FIG. 7 is a process flow showing a method for using cascading rules for cross-channel event stitching using identity graphs, in accordance with embodiments of the present disclosure.

FIG. 8 is a block diagram of an example computing device in which embodiments of the present disclosure can be employed.

### DETAILED DESCRIPTION

Businesses collect and analyze customer data to gain insights into customer behavior by gathering data from various sources and analyzing the customer data to optimize marketing strategies. Businesses utilize the collected customer data to generate performance metrics, such as conversion rates, resolution rates or other metrics, and personalize customer experiences. For example, businesses can utilize the customer data to build a comprehensive customer profile for the customer, including demographic information, behavior data, transaction history, and/or any other customer data collected for the customer to optimize personalized and/or targeted marketing strategies. As another example, businesses can implement customer journeys to trigger actions within targeted, personalized advertising campaigns for customers based on specific interactions with the customer, thereby improving customer engagement and conversion rates.

Businesses often collect customer data from different communication channels, such as web applications, mobile applications, email, short message service (“SMS”), social media platforms, call centers and/or other communication channels, and the customer data from the various communication channels often cannot be combined. For example, when a customer checks out through an online store via a web application, the business may collect the account name from the web application, a device identity, such as an experience cloud identification (“ECID”) used across Adobe Experience Platform and Adobe Experience Cloud applications, and a browser identity, such as an internet protocol (IP) address. However, when the same customer interacts with the business through a different channel, such as social media or email, to request support for the product, the business may only collect the email and social media profile of the customer. Therefore, as different customer data is collected for each of the communication channels, the customer data cannot be “stitched” together across the various communication channels resulting in fragmented customer interactions across the various communication channels.

Further, the customer will often utilize multiple devices to engage with the business through the various communication channels. For example, when the customer browses through the online store via the customer's mobile phone through the web application, but checks out through another device, such as the customer's tablet or computer, the device identity and the browser identity collected for the browsing interaction will be different than the device identity and the browser identity collected for the check-out interaction. In this regard, the browsing interaction and check-out interaction remain fragmented and cannot be “stitched” together to optimize marketing strategies and generate analytics across the different interactions.

Thus, while some existing systems “stitch” customer data together using mapped associations between a customer's user identity and customer's device, the interactions across various devices and communication channels remain fragmented to the specific communication channel and specific device due to the different device identities and user identities collected for each communication channel.

As such, currently, in order to utilize event record datasets to generate performance metrics or personalize customer experiences, a business can only generate performance metrics and personalize customer experiences with respect to a specific communication channel. Thus, the business must implement software to generate the performance metrics and personalize customer experiences on multiple systems corresponding to each communication channel, thereby unnecessarily increasing the usage of computing and networking resources. Further, the fragmentation of customer data across multiple systems causes important insights regarding the customer data to be lost. For example, customer data corresponding to interactions across multiple communication channels is unable to be combined, which may cause inaccurate or incomplete performance metrics and may cause redundant marketing efforts, thereby further unnecessarily increasing the usage of computing and networking resources.

Accordingly, unnecessary computing resources are utilized to generate performance metrics and personalize customer experiences across multiple communication channels when the customer data from the multiple communication channels are fragmented. For example, computing and network resources are unnecessarily consumed to facilitate implementing software to generate the performance metrics and personalize customer experiences on multiple systems corresponding to each communication channel. As another example, computing and network resources are unnecessarily consumed to facilitate implementing redundant marketing efforts due to the incomplete customer data. In this regard, computer input/output operations are unnecessarily increased to implement software for multiple systems corresponding to each communication channel and/or implement redundant marketing efforts due to the incomplete customer data. Further, the processing of operations to implement software for multiple systems corresponding to each communication channel and/or implement redundant marketing efforts due to the incomplete customer data decreases the throughput for a network, increases the network latency, and increases packet generation costs when the processing of the operations occur over a network.

As such, embodiments of the present disclosure are directed to cross-channel event stitching using identity graphs in an efficient and effective manner. In this regard, customer data can be efficiently and effectively combined across different communication channels in order to generate performance metrics and/or personalize customer experiences across the different communication channels.

Generally, and at a high level, embodiments described herein facilitate using identity graphs to append event records of event record datasets from different communication channels to include a common identity namespace in order generate performance metrics and/or personalize customer experiences across the different communication channels. For example, event records regarding interactions with users are collected from various communication channels, such as web applications, mobile applications, email, SMS, social media platforms, call centers and/or other communication channels, or combinations thereof, via a corresponding event collection component for each communication channel. The event records of the event record datasets from the various communication channels and/or profile record datasets are used to generate identity graphs for the users. An identity namespace is selected to be used as the graph lookup identity namespace for the event record datasets from the different communication channels. In some embodiments, different identity namespaces can be selected to be used as the graph lookup identity namespace for different event record datasets from the different communication channels. A different identity namespace that may not available in some of the event record datasets is selected to be used as the common identity namespace to be used across the event record datasets from the different communication channels. The identity value of the selected graph lookup identity namespace is then determined for each event record of the event record datasets from the different communication channels. A graph lookup is then performed on the identity graphs using the determined identity values of the selected graph lookup identity namespace for each event record of the event record datasets from the different communication channels to determine the corresponding identity value of the selected common identity namespace for each event record. Each event record of the event record datasets from the different communication channels are appended to include the corresponding determined identity value of the selected common identity namespace for the corresponding event (e.g., in an additional column appended to the event records). As each of the event records from the different communication channels are appended to include a common identity, the event records can be utilized to generate performance metrics and/or personalize customer experiences across the different communication channels.

In some embodiments, a set of identity namespaces are selected as the potential graph lookup identity namespace and priority values are assigned to each identity namespace of the set of potential graph lookup identity namespaces. The identity value of the graph lookup identity namespace for each event record of the event record datasets from the different communication channels is then determined based on the availability of the identity value of the graph lookup identity namespace with the highest priority in each event record. Further, a set of identity namespaces are selected as the potential common identity namespace, and priority values are assigned to each identity namespace of the set of potential common identity namespaces. The identity value of the common identity namespace for each event record of the event record datasets from the different communication channels is then determined based on the availability of the identity value of the common identity namespace with the highest priority in each identity graph. In this regard, the selected priority of graph lookup identity namespaces and/or the selected priority of common identity namespaces can be applied to all of the event record datasets of the different communication channels even when different identity namespaces are collected through the different communication channels.

In operation, when a user (also referred to herein as “customer”), such as a customer or potential customer, interacts with a business, such as through a website of the business, the business collects customer data corresponding to the interaction (referred to herein as an “event record”). For example, an event record may include the device identity when a customer navigates to a website, data indicating that the device navigated to the website, and data indicating the time when the interaction occurred. A subsequent event record may include the device identity and account name for the customer when the customer logs in to the website, data indicating that the customer logged in to the website, and data indicating the time when the interaction occurred. A further subsequent event record may include the device identity and account name for the customer when the customer purchases a product through the website, data indicating that the customer purchased the product, and data indicating the time when the interaction occurred.

In this regard, a business collects event records from various communication channels, such as web applications, mobile applications, email, SMS, social media platforms, call centers and/or other communication channels, or combinations thereof, via a corresponding event collection component for each communication channel. In some embodiments, each communication channel is further subdivided based on the platform, such as each mobile application for Apple and Google can be a separate communication channel. The event records for each communication channel are then stored in a corresponding event record dataset for each communication channel. For example, each event record dataset for each communication channel can be stored in a separate database of the corresponding communication channel. In certain embodiments, a business collects and stores profile record datasets for various communication channels (e.g., in the database for the corresponding communication channel). For example, a customer may create a customer profile and enter certain information, such as their email address, account name, phone number, and/or any customer data. The business can then store profile records for customers in the profile record dataset of the corresponding communication channel.

At a high level, “identity stitching” generally refers to the process of linking multiple identities (e.g., customer accounts, email addresses, device IDs, browser IDs, etc.) across various platforms to a single individual, such as a customer of a business, even when they occur through different communication channels. “Event stitching” generally refers to the process of applying the linked identities determined through the process of identity stitching to event records in order to associate previously fragmented customer interactions with a single customer. Among other applications, identity stitching and event stitching enable businesses to convert a previously anonymous event record into an authenticated event record associated with a customer, such as when a customer interacts with a website of a business without logging into their account using a device associated with the customer based on customer data from other event records. The business can then build a comprehensive customer profile for the customer utilizing the authenticated event records, including demographic information, behavior data, transaction history, and/or any other customer data collected for the customer, to generate performance metrics and optimize personalized and/or targeted marketing strategies.

With respect to identity stitching, in some embodiments, the event records of the event record datasets and/or profile records of the profile record datasets are used to determine identity graphs for the users. An identity graph provides a mapping of relationships between different identities (e.g., represented as an identity node) of a particular individual. An identity graph is a data structure, such as a table in a database, knowledge graph, and/or other data structure, that maps and visualizes the relationships between various identities associated with a particular customer across multiple platforms and touchpoints. For example, an identity graph for a customer can include an association of a device identity with a customer's account name based on an event record with data indicating that a customer logged into the account using the particular device. In this regard, identity graphs can be determined utilizing the event record datasets from different communication channels and/or profile record datasets from different communication channels. For example, an identity graph can include a mapping of relationships between the phone number associated with an account name collected from an event record dataset from an event collection component of a call center communication channel, the device identity of a device used to login to the account name via a website from an event record dataset from an event collection component of a web application communication channel, and an email address associated with the account name from an event record dataset from an event collection component of an email communication channel.

In some embodiments, an identity graph includes identity nodes, which represent unique identities, such as user identities and device identities, and edges, which depict the relationships or connections between identity nodes (e.g., linking an individual's email address to their phone number, which indicates the identities belong to the same individual). A “device identity” generally refers to an identifier of a particular device. Examples of device identities include an ECID, a media access control (“MAC”) address, an international mobile equipment identity (“IMEI”), a unique device identifier (“UDID”), a universally unique identifier (“UUID”), an identifier for advertisers (“IDFA”), a Google advertising identifier (“GAID”), an Android advertising identity (“AAID”), an internet protocol (“IP”) address, a browser identifier, a hypertext transfer protocol (HTTP) cookie, and other device identifiers. A “user identity” generally refers to an identifier of a particular user, such as a customer or potential customer. Examples of user identities include an account name, a customer relationship management (CRM) identity, an email address, a phone number, a legal name, and other user identifiers.

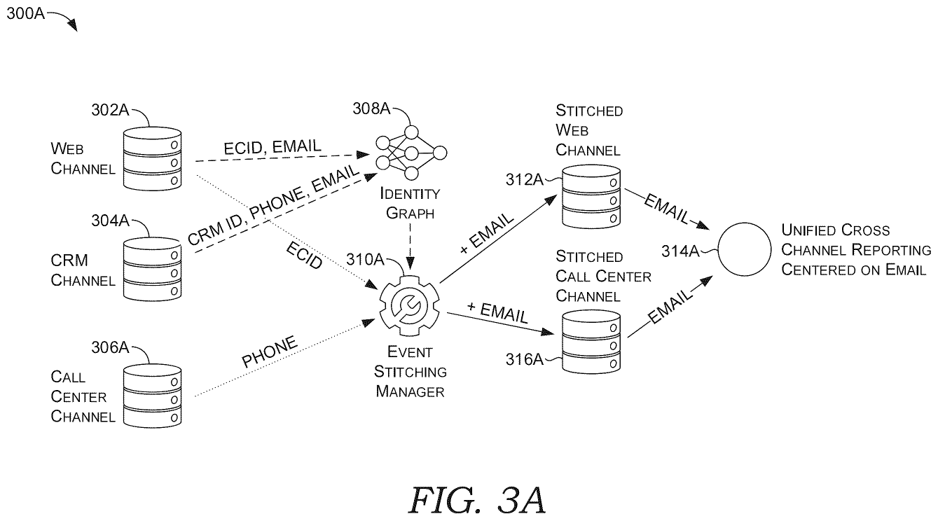

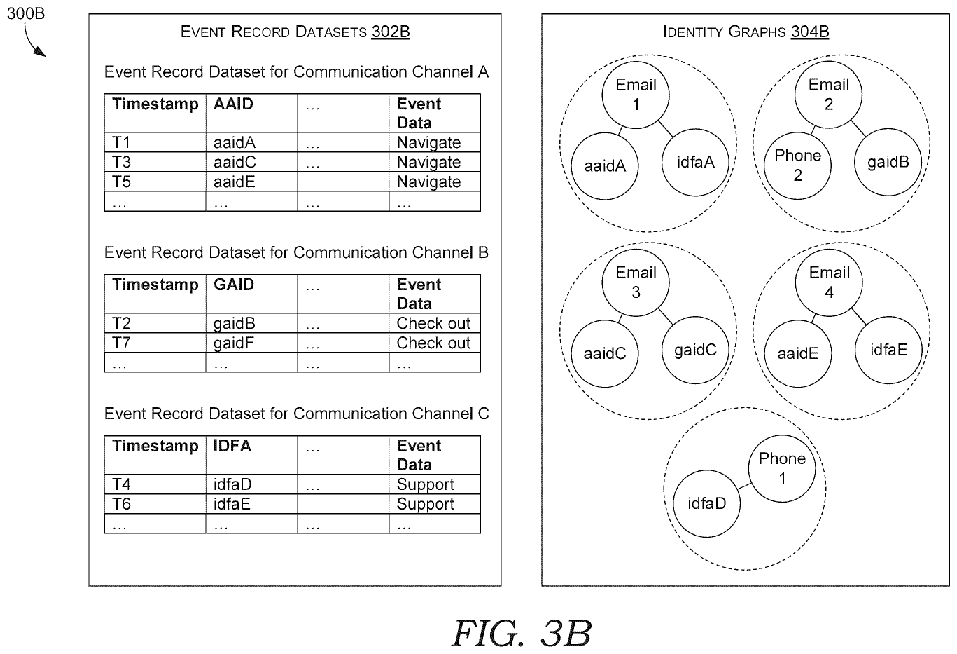

In some embodiments, each identity node of an identity graph includes an identity namespace and an identity value, such as an identity namespace for “Email”, and an identity value of “example@example.com”. Each edge can include various properties regarding the relationship between the identity nodes, such as properties related to events establishing the relationship between the identity nodes (e.g., a first established timestamp and a last updated timestamp). The first established timestamp of an edge can include the date and time at which a new identity node is linked to an existing identity node. The last updated timestamp can include the date and time at which an existing link between identity nodes was last updated (e.g., by a subsequent event record for the particular customer). For example, the first established timestamp of an edge between a device identity and a user identity may indicate the first time that a customer navigates to a product website using a device associated with the device identify while logged in with the customer identity. The last updated timestamp of an edge between a device identity and a customer identity may indicate the most recent time the customer navigates to the product website using the device associated with the device identity while logged in with the customer identity. An example of an identity graph is shown by identity graphs 304B of FIG. 3B.

With respect to event stitching, in certain embodiments, the event records of the event record datasets from the different communication channels are accessed in order to associate previously fragmented customer interactions with associated customers via a common identity namespace (also referred to herein as a “stitched ID”) determined using the identity graphs. In this regard, an identity namespace is selected, such as an identity namespace of a device identity (also referred to herein as a “device identity namespace”) and/or an identity namespace of a user identity (also referred to herein as a “user identity namespace”), to be used as the graph lookup identity namespace for the event record datasets from the different communication channels. For example, an individual performing event stitching on behalf of a business can select a device identity namespace as the graph lookup identity namespace that is most abundantly available in a corresponding event record dataset of a communication channel (e.g., the event collection component of the communication channel most often collects the identity value of the selected device identity namespace when collecting customer data for event records).

In some embodiments, a corresponding identity namespace is selected as the graph lookup identity namespace for each event record dataset of each communication channel of the different communication channels. For example, the selected device identity namespace for the event record dataset of one communication channel can be different than the selected device identity namespace for the event record dataset of another communication channel.

In certain embodiments, the identity value of the selected graph lookup identity namespace is then determined for each event record of the event record datasets from the different communication channels. For example, an individual performing event stitching on behalf of a business can select the device identity namespace of “ECID” for an event record dataset from an event collection component of a web application communication channel and the device identity namespace of “IDFA” for an event record dataset from an event collection component of a mobile application communication channel. In this regard, the identity value of each ECID (e.g., 111111111111) can be determined for each event record of the event record dataset from the event collection component of the web application communication channel and the identity value of each IDFA (e.g., 222222222222) can be determined for each event record of the event record dataset from the event collection component of the mobile application communication channel.

In some embodiments, a set of identity namespaces are selected as the potential graph lookup identity namespace and priority values are assigned to each identity namespace of the set of potential graph lookup identity namespaces. The identity value of the graph lookup identity namespace for each event record of the event record datasets from the different communication channels is then determined based on the availability of the identity value of the graph lookup identity namespace with the highest priority in each event record (e.g., from the selected priority of graph lookup identity namespaces). For example, an individual performing event stitching on behalf of a business can select the device identity namespace of “ECID” as the highest priority and the device identity namespace of “IDFA” with a lower priority. In this regard, when an event record includes an ECID value, the ECID value is determined to be the identity value of the graph lookup identity namespace for the event record. However, when an ECID value is unavailable in the event record, the IDFA value is determined to be the identity value of the graph lookup identity namespace for the event record. In this regard, in some embodiments, the selected priority of graph lookup identity namespaces can be applied to all of the event record datasets of the different communication channels.

Continuing with event stitching, in certain embodiments, an identity namespace, such as a device identity namespace or a user identity namespace, is selected to be used as the common identity namespace (e.g., as the stitched ID) to be used across the event record datasets from the different communication channels. A graph lookup is then performed on the identity graphs using the determined identity values of the selected graph lookup identity namespace for each event record of the event record datasets from the different communication channels to determine the corresponding identity value of the selected common identity namespace for each event record. For example, an individual performing event stitching on behalf of a business can select a user identity namespace of “email” as the common identity namespace. The determined identity value of the selected graph lookup identity namespace for an event record (e.g., ECID: 111111111111) is used to determine a corresponding identity graph with an identity node with the same identity value for the identity namespace. The identity value of the selected common identity namespace (e.g., email: example@example.com) is then determined from a different corresponding identity node of the same corresponding identity graph. The identity value of the selected common identity namespace (e.g., email: example@example.com) is determined to be the identity value of the common identity namespace for the corresponding event record.

In some embodiments, a set of identity namespaces are selected as the potential common identity namespace and priority values are assigned to each identity namespace of the set of potential common identity namespaces. The identity value of the common identity namespace for each event record of the event record datasets from the different communication channels is then determined based on the availability of the identity value of the common identity namespace with the highest priority in each identity graph (e.g., from the selected priority of common identity namespaces). For example, an individual performing event stitching on behalf of a business can select the user identity namespace of “account name” as the highest priority and the user identity namespace of “email” with a lower priority. In this regard, when performing the graph lookup of a corresponding identity graph (e.g., determined using the identity value of the selected graph lookup identity namespace) and the corresponding identity graph includes an account name (e.g., Account1), the account name is determined to be the identity value for the common identity namespace for the event record. However, when an account name is unavailable in the corresponding identity graph, the email address (e.g., example@example.com) is determined to be the identity value of the common identity namespace for the event record.

In some embodiments, the selected graph lookup identity namespace (e.g., and/or selected priority of graph lookup identity namespaces) is only selected from device identity namespaces and the selected common identity namespace (e.g., and/or selected priority of common identity namespaces) is only selected from user identity namespaces. In some embodiments, when the selected common identity namespace (e.g., and/or selected priority of common identity namespaces) is unavailable in the corresponding identity graph after performing the graph lookup, the common identity namespace can be set to the identity value of the graph lookup identity namespace. In some embodiments, if there are multiple identity values for the same identity namespace, timestamps and/or other provided rankings of the identity values can be used to determine which identity value to use. For example, when there are multiple identity values available for the selected common identity namespace (e.g., and/or selected priority of common identity namespaces), the identity value with the most recent timestamp (e.g., which can be indicated by the edge properties in the identity graph) can be used as the identity value for the selected common identity namespace.

Continuing with event stitching, in certain embodiments, each event record of the event record datasets from the different communication channels are appended to include the corresponding determined identity value of the selected common identity namespace (e.g., and/or selected priority of common identity namespaces) for the corresponding event. Examples of an event stitching are shown in FIGS. 3A-5C.

In certain embodiments, as each of the event records from the different communication channels are appended to include a common identity, businesses can utilize the event records to generate performance metrics, such as conversion rates, resolution rates or other metrics across the different communication channels, and/or personalize customer experiences across the different communication channels. In some embodiments, businesses can utilize the appended event records to build a comprehensive customer profile for the customer across the different communication channels, including demographic information, behavior data, transaction history, and/or any other customer data collected for the customer to optimize personalized and/or targeted marketing strategies. In some embodiments, businesses can implement customer journeys to trigger actions within targeted, personalized advertising campaigns for customers based on specific interactions with the customer across the different communication channels. In some embodiments, a metric can be generated corresponding to a percentage of the event records of the event record datasets from different communication channels that are appended to include a corresponding detected identity value for the selected common identity namespace and/or selected priority of common identity namespaces.

Advantageously, efficiencies of computing and network resources can be enhanced using implementations described herein. In particular, implementing cross-channel event stitching using identity graphs to efficiently and effectively combine customer data cross different communication channels to generate performance metrics and/or personalize customer experiences across the different communication channels provides for a more efficient use of computing resources (e.g., reduced computer input/output operations, higher throughput and reduced latency for a network, less packet generation costs, etc.) than implementing software for multiple systems corresponding to each communication channel and/or implementing redundant marketing efforts due to the incomplete customer data (e.g., as the customer data is fragmented across the different communication channels). The technology described herein results in less input/output operations, less information over a computer network, which results in higher throughput, reduced latency, less packet generation costs as fewer packets are sent over a network, etc. Therefore, the technology described herein conserves computing and network resources.

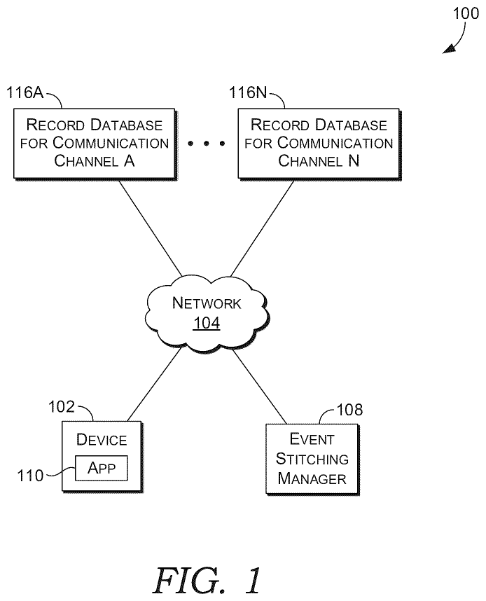

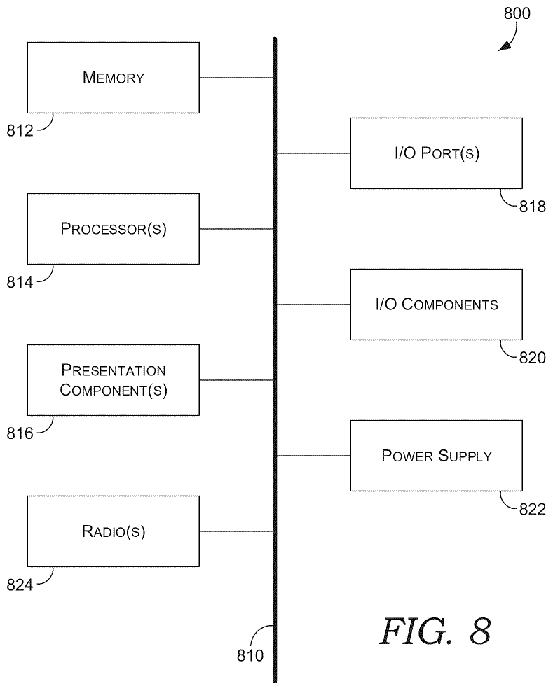

Turning to the figures, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 8.

It should be understood that operating environment 100 shown in FIG. 1 is an example of one suitable operating environment. Among other components not shown, operating environment 100 includes a device 102, application 110, network 104, record databases for communication channels A-N 116A-N, and event stitching manager 108. Each of the components shown in FIG. 1 can be implemented via any type of computing device, such as one or more of computing device 800 described in connection to FIG. 8, for example.

These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

Device 102 can be any type of computing device capable of being operated by an individual(s) (e.g., a user implementing event stitching on behalf of a business in order to generate performance metrics or personalized and/or targeted marketing strategies). For example, in some implementations, such devices are the type of computing device described in relation to FIG. 8. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The device 102 can include one or more processors, and one or more computer-readable media. The computer-readable media may include computer-readable instructions executable by the one or more processors. The instructions may be embodied by one or more applications, such as application 110 shown in FIG. 1. Application 110 is referred to as single applications for simplicity, but its functionality can be embodied by one or more applications in practice.

Application 110 operating on device 102 can generally be any application capable of utilizing event records for identity stitching and/or event stitching in order to generate performance metrics or personalized and/or targeted marketing strategies, such as a customer experience management platform. In some implementations, the application 110 comprises a web application, which can run in a web browser, and could be hosted at least partially server-side (e.g., via event stitching manager 108). In addition, or instead, the application 110 can comprise a dedicated application. In some cases, the application 110 is integrated into the operating system (e.g., as a service). Such an application may be accessed via a mobile application, a web application, or the like.

In some embodiments, application 110 operation on device 102 can facilitate generating performance metrics, updating user profiles and/or updating of journeys based on event record datasets (e.g., as determined by event stitching manager 108). A “journey,” “user journey,” or “customer journey” refers to a series or sequence of interactions between a customer and a business over time. Journeys occur over various channels, such as e-mail, phone calls/texting, social media, websites, physical locations, and any channel in which a customer and business interact. A journey can include a set of one or more events, conditions, and/or corresponding actions (e.g., responses). An “event” refers to an interaction of a customer with a business or that a business performs on behalf of a customer. Examples of events include selecting or clicking on a particular product, purchasing a particular product, navigating to a particular website, opening an e-mail, clicking a link, contacting customer service, entering and/or existing a retail brick-and-mortar store, and the like. Events can be used in journeys to trigger certain actions by the business, such as automated messaging. An event can be represented as a JavaScript Object Notation (“JSON”) with nested fields corresponding to data regarding each event. A “condition” refers to a rule or set of rules that are evaluated based on certain events and/or customer data and are used to determine next interactions in a journey. For example, a customer may abandon an online cart and a business may set a condition to send a communication regarding the abandoned cart after a period of time. An “action” (e.g., response) refers to a specific response triggered by an event or conditions within a journey. Actions are used to automate personalized customer journeys by taking specific steps for specific customers when customers perform certain interactions (e.g., an event occurs) or certain conditions are met for the customer. Examples of actions include sending an e-mail, displaying a message on a website, updating a customer record/profile, or any action that a business takes with respect to its customer or potential customer.

Device 102 can be a client device on a client-side of operating environment 100, while event stitching manager 108 can be on a server-side of operating environment 100. Event stitching manager 108 may comprise server-side software designed to work in conjunction with client-side software on device 102 so as to implement any combination of the features and functionalities discussed in the present disclosure. An example of such client-side software is application 110 on device 102. This division of operating environment 100 is provided to illustrate one example of a suitable environment, and it is noted there is no requirement for each implementation that any combination of device 102 or event stitching manager 108 to remain as separate entities.

Application 110 operating on device 102 can generally be any application capable of facilitating the exchange of information between the device 102 and the event stitching manager 108 in displaying and exchanging information regarding event records, identity graphs, performance metrics, customer profiles, and/or the like. In some implementations, the application 110 comprises a web application, which can run in a web browser, and could be hosted at least partially on the server-side of environment 100. In addition, or instead, the application 110 can comprise a dedicated application. In some cases, the application 110 is integrated into the operating system (e.g., as a service). It is therefore contemplated herein that “application” be interpreted broadly.

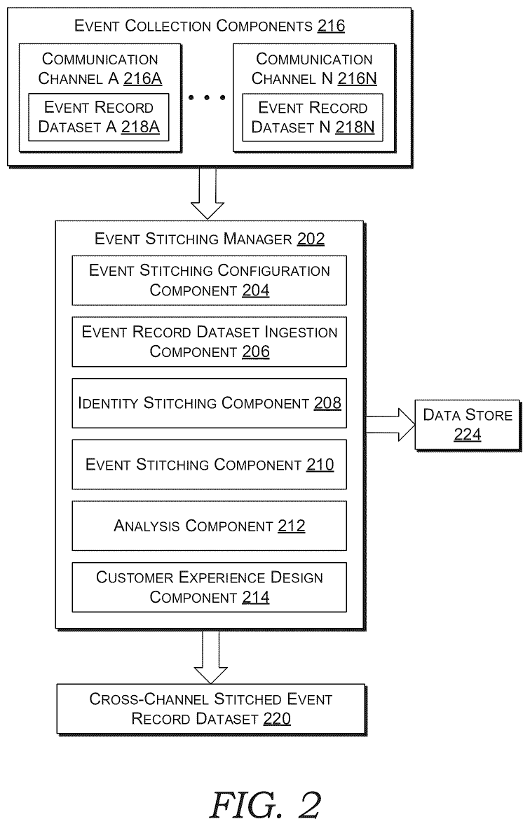

The event stitching manager 108 can obtain user data from device 102, customer data regarding event records and/or profile records from record databases for communication channels A-N 116A-N, and any other data sources. Record databases for communication channels A-N 116A-N may be any type of source providing data (e.g., customer data) from any type of communication channel, such as web applications, mobile applications, email, SMS, social media platforms, call centers and/or other communication channels, or combinations thereof. Generally, the record databases for communication channels A-N 116A-N receives data from any number of devices. As such, each record databases for communication channels A-N 116A-N can include a corresponding event collection component (e.g., event collection components 216 of FIG. 2) to collect data from various user devices, such as device 102, and other data sources. In this regard, the event stitching manager 108 can retrieve or access data collected or identified at various components, such as record databases for communication channels A-N 116A-N, or sensors associated therewith.

As described, in some cases, the event stitching manager 108 can retrieve or access customer data from record databases for communication channels A-N 116A-N. Customer data within a dataset may include, by way of example and not limitation, data that is sensed or determined from one or more sensors, such as user identities, device identities, event data, location information of mobile device(s), smartphone data (such as device identity, phone number, phone state, charging data, date/time, or other information derived from a smartphone), activity information (for example: email addresses, account name, browser identity, app usage; online activity; searches; browsing certain types of webpages; listening to music; taking pictures; voice data such as automatic speech recognition; activity logs; communications data including calls, texts, instant messages, and emails; website posts; other user data associated with communication events) including activity that occurs over more than one device, user history, session logs, application data, contacts data, calendar and schedule data, notification data, social network data, news (including popular or trending items on search engines or social networks), online gaming data, ecommerce activity, sports data, health data, and nearly any other source of data that may be used to identify the customer, as described herein.

Such customer data can be initially collected at remote locations or systems and transmitted to a data store (e.g., record databases for communication channels A-N 116A-N) of the corresponding communication channel for access by event stitching manager 108. In accordance with embodiments described herein, customer data collection may occur at record databases for communication channels A-N 116A-N, respectively. In some cases, record databases for communication channels A-N 116A-N or portion thereof, may be client devices that is, computing devices operated by businesses, for example. As such, client devices, or components associated therewith, can be used to collect various types of customer data. For example, in some embodiments, customer data may be obtained and collected at a device operated by a customer via one or more sensors, which may be communicated to one or more client devices and/or other computing devices. As used herein, a sensor may include a function, routine, component, or combination thereof for sensing, detecting, or otherwise obtaining information, such as customer data, and may be embodied as hardware, software, or both.

In addition or in the alternative to record databases for communication channels A-N 116A-N including client devices, record databases for communication channels A-N 116A-N may include servers, data stores, or other components that collect customer data, for example, from devices associated with customers, websites, application, and/or the like. For example, in interacting with a client device, datasets may be captured at record databases for communication channels A-N 116A-N and, thereafter, such customer data can be stored and utilized by event stitching manager 108. Customer data may additionally or alternatively be obtained from an external server that stores the respective event record datasets of each communication channel, for example. Customer data can be obtained from record databases for communication channels A-N 116A-N periodically or in an ongoing manner (or at any time) and provided to the event stitching manager 108 to facilitate identity stitching and/or event stitching.

As described herein, event stitching manager 108 can facilitate cross-channel event stitching using identity graphs. Event stitching manager 108 can be or include a server, including one or more processors, and one or more computer-readable media. The computer-readable media includes computer-readable instructions executable by the one or more processors. The instructions can optionally implement one or more components of event stitching manager 108, described in additional detail below with respect to event stitching manager 202 of FIG. 2.

At a high level, event stitching manager 108 performs various functionality to facilitate using identity graphs to append event records of event record datasets from different communication channels to include a common identity namespace in order generate performance metrics and/or personalize customer experiences across the different communication channels. In this regard, event stitching manager 108 can access event records and/or profile records with customer data, perform identity stitching, perform event stitching, generate performance metrics, personalize customer experiences, and/or the like via application 110 of the device 102. The event records, profile records, identity graphs, performance metrics, customer profiles, and/or the like can be displayed via a display screen of the device 102 and may be presented in any manner.

For cloud-based implementations, the instructions on event stitching manager 108 can implement one or more components, and application 110 can be utilized by a user to interface with the functionality implemented on event stitching manager 108. In some cases, application 110 comprises a web browser. In other cases, event stitching manager 108 may not be required. For example, the components of event stitching manager 108 may be implemented completely on a client device, such as device 102. In this case, event stitching manager 108 may be embodied at least partially by the instructions corresponding to application 110.

Thus, it should be appreciated that event stitching manager 108 may be provided via multiple devices arranged in a distributed environment that collectively provide the functionality described herein. Additionally, other components not shown may also be included within the distributed environment. In addition, or instead, event stitching manager 108 can be integrated, at least partially, into a device, such as device 102. Furthermore, event stitching manager 108 may at least partially be embodied as a cloud computing service.

Referring to FIG. 2, aspects of an illustrative event stitching management system are shown, in accordance with various embodiments of the present disclosure. At a high level, event stitching management system can facilitate using identity graphs to append event records of event record datasets from different communication channels to include a common identity namespace in order generate performance metrics and/or personalize customer experiences across the different communication channels.

As shown in FIG. 2, event stitching manager 202 includes event stitching configuration component 204, event record dataset ingestion component 206, identity stitching component 208, event stitching component 210, analysis component 212, and customer experience design component 214. In the example shown in FIG. 2, event record datasets A-N 218A-N are collected by event collection components 216 of different communication channels A-N 216A-N (e.g., that are stored in record databases for communication channels A-N 116A-N of FIG. 1) and stored in data store 224. The event record datasets A-N 218A-N are accessed by event stitching manager 202 (e.g., via event record dataset ingestion component 206). Event stitching manager 202 generates identity graphs (e.g., via identity stitching component 208) based on the event record datasets A-N 218A-N (e.g., and/or profile records of the profile record datasets accessed from record databases for communication channels A-N 116A-N of FIG. 1). Event stitching manager appends event records of event record datasets A-N 218A-N to include a common identity namespace and outputs cross-channel stitched event record dataset (e.g., via event stitching component 208) in order generate performance metrics (e.g., via analysis component 212) and/or personalize customer experiences (e.g., via customer experience design component 214) across the different communication channels A-N 216A-N.

The event stitching manager 202 can communicate with the data store 224. The data store 224 is configured to store various types of information accessible by event stitching manager 202, or other server or component. The foregoing components of event stitching manager 202 can be implemented, for example, in operating environment 100 of FIG. 1. In particular, those components may be integrated into any suitable combination of devices 102 and/or event stitching manager 108.

In embodiments, data sources, such as data sources storing event record datasets A-N from the event collection components 216 of the different communication channels A-N 216A-N, data sources storing profile record datasets from different communication channels A-N 216A-N (e.g., stored in record databases for communication channels A-N 116A-N of FIG. 1), devices (such as device 102 of FIG. 1), and event stitching manager 202 can provide data to the data store 224 for storage, which may be retrieved or referenced by any such component. As such, the data store 224 can store computer instructions (e.g., software program instructions, routines, or services), data and/or models used in embodiments described herein. In some implementations, data store 224 can store information or data received or generated via the various components of event stitching manager 202 and provides the various components with access to that information or data, as needed. The information in data store 224 may be distributed in any suitable manner across one or more data stores for storage (which may be hosted externally).

The event stitching configuration component 204 is generally configured to allow an individual performing event stitching on behalf of a business to configure the event stitching parameters, such as by selecting priority values of graph lookup identity namespaces and/or common identity namespaces. In embodiments, event stitching configuration component 204 can include rules, conditions, associations, models, algorithms, or the like to allow an individual to configure the event stitching parameters. The event record dataset ingestion component 206 is generally configured to access the event record datasets from the different communication channels. In embodiments, event record dataset ingestion component 206 can include rules, conditions, associations, models, algorithms, or the like to access the event record datasets from the different communication channels. The identity stitching component 208 is generally configured to generate identity graphs based on the event record datasets from the different communication channels and/or profile record datasets from the databases of the different communication channels. In embodiments, identity stitching component 208 can include rules, conditions, associations, models, algorithms, or the like to generate identity graphs based on the event record datasets from the different communication channels and/or profile record datasets from the databases of the different communication channels. The event stitching component 210 is generally configured to use identity graphs to perform event stitching to the event record datasets from the different communication channels. In embodiments, event stitching component 210 can include rules, conditions, associations, models, algorithms, or the like to use identity graphs to perform event stitching to the event record datasets from the different communication channels.

The analysis component 212 is generally configured to allow an individual to generate performance metrics across the different communication channels using the stitched event record datasets. In embodiments, analysis component 212 can include rules, conditions, associations, models, algorithms, or the like to generate performance metrics across the different communication channels using the stitched event record datasets. For example, analysis component 212 may comprise a statistical model, fuzzy logic, neural network, finite state machine, support vector machine, logistic regression, clustering, or machine-learning techniques, similar statistical classification processes, or combinations thereof to generate performance metrics across the different communication channels using the stitched event record datasets.

The customer experience design component 214 is generally configured to allow an individual to personalize customer experiences across the different communication channels using the stitched event record datasets. In embodiments, customer experience design component 214 can include rules, conditions, associations, models, algorithms, or the like to personalize customer experiences across the different communication channels using the stitched event record datasets. For example, customer experience design component 214 may comprise a statistical model, fuzzy logic, neural network, finite state machine, support vector machine, logistic regression, clustering, or machine-learning techniques, similar statistical classification processes, or combinations thereof to personalize customer experiences across the different communication channels using the stitched event record datasets.

In embodiments, a business collects event records from various communication channels, such as web applications, mobile applications, email, SMS, social media platforms, call centers and/or other communication channels, or combinations thereof, via a corresponding event collection component for each communication channel (e.g., event collection components 216). In some embodiments, each communication channel is further subdivided based on the platform, such as each mobile application for Apple and Google can be a separate communication channel. The event records for each communication channel are then stored in a corresponding event record dataset (e.g., event record dataset A 218A and event record dataset N 218N) for each communication channel (e.g., communication channel A 216A and communication channel N 216N). For example, each event record dataset for each communication channel can be stored in a separate database of the corresponding communication channel (e.g., record databases for communication channels A-N 116A-N of FIG. 1). In certain embodiments, a business collects and stores profile record datasets for various communication channels. For example, a customer may create a customer profile and enter certain information, such as their email address, account name, phone number, and/or any customer data. The business can then store profile records for customers in the profile record dataset of the corresponding communication channel (e.g., record databases for communication channels A-N 116A-N of FIG. 1).

In some embodiments, the event records of the event record datasets from the different communication channels and/or profile records of the profile record datasets of the different communication channels are accessed by event stitching configuration component 204. The event records of the event record datasets are used by identity stitching component 208 to determine identity graphs for the users. In certain embodiments, profile record datasets from the databases of the different communication channels are used by identity stitching component 208 to determine identity graphs for the users. The identity graphs can then be stored in data store 224 for access via event stitching manager 202. In some embodiments, an identity graph generated by identity stitching component 208 includes identity nodes, which represent unique identities, such as user identities and device identities, and edges, which depict the relationships or connections between identity nodes (e.g., linking an individual's email address to their phone number, which indicates the identities belong to the same individual). In some embodiments, each identity node of an identity graph generated by identity stitching component 208 includes an identity namespace and an identity value, such as an identity namespace for “Email”, and an identity value of “example@example.com”. In some embodiments, each edge generated by identity stitching component 208 can include various properties regarding the relationship between the identity nodes, such as properties related to events establishing the relationship between the identity nodes (e.g., a first established timestamp and a last updated timestamp). An example of an identity graph is shown by identity graphs 304B of FIG. 3B. As can be understood from FIG. 3B, profile record datasets and/or event record datasets (e.g., such as event record datasets 302B) from various communication channels can be used to determine identity graphs 304B that provide mappings of relationships between different identities.

For example, with respect to the identity graph of identity graphs 304B mapping the relationship between “Email 1,” “aaidA” and “idfaA,” a first event record can be collected indicating that a customer logged into an account utilizing a user identity of “Email 1” on a device with a device identity of “aaidA” and a second event record can be collected indicating that a customer logged into an account utilizing the user identity of “Email 1” on a device with a device identity of “idfaA.” With respect to the identity graph of identity graphs 304B mapping the relationship between “Email 2” and “gaidB,” an event record can be collected indicating that a customer logged into an account utilizing a user identity of “Email 2” on a device with a device identity of “gaidB.” With respect to the identity graph of identity graphs 304B mapping the relationship between “Email 3,” “aaidC” and “gaidC,” a first event record can be collected indicating that a customer logged into an account utilizing a user identity of “Email 3” on a device with a device identity of “aaidC” and a second event record can be collected indicating that a customer logged into an account utilizing the user identity of “Email 3” on a device with a device identity of “gaidC.” With respect to the identity graph of identity graphs 304B mapping the relationship between “Email 4,” “aaidE” and “idfaE,” a first event record can be collected indicating that a customer logged into an account utilizing a user identity of “Email 4” on a device with a device identity of “aaidE” and a second event record can be collected indicating that a customer logged into an account utilizing the user identity of “Email 4” on a device with a device identity of “idfaE.” With respect to the identity graph of identity graphs 304B mapping the relationship between “Phone 1” and “idfaD,” an event record can be collected indicating that a customer logged into an account utilizing a user identity of “Phone 1” on a device with a device identity of “idfaD.”

Continuing with the example shown in FIG. 3B, subsequent event record datasets 302B are collected from various communication channels. The event record datasets 302B show examples of the device identities and examples of event data collected at the various communication channels. The event record datasets 302B can include other customer data collected for each of the event records, such as other device identities or user identities collected. The event record datasets 302B can then be utilized for identity stitching and/or event stitching.

Returning to FIG. 2, in certain embodiments, the event records of the event record datasets from the different communication channels are accessed by event stitching component 210 in order to associate previously fragmented customer interactions with associated customers via a common identity namespace determined using the identity graphs. In this regard, an identity namespace is selected via event stitching configuration component 204, such as a device identity namespace and/or a user identity namespace, to be used as the graph lookup identity namespace for the event record datasets from the different communication channels. For example, an individual performing event stitching on behalf of a business can select a device identity namespace via event stitching configuration component 204 as the graph lookup identity namespace that is most abundantly available in a corresponding event record dataset of a communication channel. In some embodiments, a corresponding identity namespace is selected via event stitching configuration component 204 as the graph lookup identity namespace for each event record dataset of each communication channel of the different communication channels. For example, the selected device identity namespace for the event record dataset of one communication channel can be different than the selected device identity namespace for the event record dataset of another communication channel.

In certain embodiments, the identity value of the selected graph lookup identity namespace is then determined by event stitching component 210 for each event record of the event record datasets from the different communication channels. In some embodiments, a set of identity namespaces are selected via event stitching configuration component 204 as the potential graph lookup identity namespace and priority values are selected via event stitching configuration component 204 and assigned to each identity namespace of the set of potential graph lookup identity namespaces. The identity value of the graph lookup identity namespace for each event record of the event record datasets from the different communication channels is then determined via event stitching component 210 based on the availability of the identity value of the graph lookup identity namespace with the highest priority in each event record (e.g., from the selected priority of graph lookup identity namespaces).

In certain embodiments, an identity namespace, such as a device identity namespace or a user identity namespace, is selected via event stitching configuration component 204 to be used as the common identity namespace (e.g., as the stitched ID) to be used across the event record datasets from the different communication channels. A graph lookup is then performed by event stitching component 210 on the identity graphs (e.g., generated by identity stitching component 208) using the determined identity values of the selected graph lookup identity namespace for each event record of the event record datasets from the different communication channels to determine the corresponding identity value of the selected common identity namespace for each event record. In some embodiments, a set of identity namespaces are selected via event stitching configuration component 204 as the potential common identity namespace and priority values are selected via event stitching configuration component 204 and assigned to each identity namespace of the set of potential common identity namespaces. The identity value of the common identity namespace for each event record of the event record datasets from the different communication channels is then determined by event stitching component 210 based on the availability of the identity value of the common identity namespace with the highest priority in each identity graph (e.g., from the selected priority of common identity namespaces).

In some embodiments, the selected graph lookup identity namespace (e.g., and/or selected priority of graph lookup identity namespaces) is only selected via event stitching configuration component 204 from device identity namespaces and the selected common identity namespace (e.g., and/or selected priority of common identity namespaces) is only selected via event stitching configuration component 204 from user identity namespaces. In some embodiments, when an identity value of the selected common identity namespace (e.g., and/or selected priority of common identity namespaces) is unavailable in the corresponding identity graph after performing the graph lookup, the identity value of the common identity namespace can be determined to be the identity value of the graph lookup identity namespace by event stitching component 210. In some embodiments, if there are multiple identity values for the same identity namespace, timestamps and/or other provided rankings of the identity values (e.g., which may be provided via event stitching configuration component 204) can be used by event stitching component 210 to determine which identity value to use. For example, when there are multiple identity values available for the selected common identity namespace (e.g., and/or selected priority of common identity namespaces), the identity value with the most recent timestamp (e.g., which can be indicated by the edge properties in the identity graph) can be determined to be the identity value for the selected common identity namespace by event stitching component 210.

In certain embodiments, each event record of the event record datasets from the different communication channels are appended to include the corresponding determined identity value of the selected common identity namespace (e.g., and/or selected priority of common identity namespaces) for the corresponding event by event stitching component 210. In certain embodiments, the stitched event record datasets (e.g., appended to include selected common identity namespace) from the different communication channels are combined into a cross-channel stitched event record dataset 220. The stitched event record datasets and/or the cross-channel stitched event record dataset can be stored in data store 224 for access by event stitching manager 202.

Examples of an event stitching are shown in FIGS. 3A-5C. As can be understood from the example diagram 300A of FIG. 3A, profile record datasets and/or event record datasets, such as event record dataset from web channel 302A and event record dataset from CRM channel 304A, are utilized to generate identity graphs 308A. Event stitching manager 310A accesses selected event record datasets, such as event record dataset from web channel 302A and event record dataset from call center channel 306A, for cross-channel event stitching. For each event record of the selected event record dataset from web channel 302A and the selected event record dataset from call center channel 306A, the event stitching manager performs a graph lookup of the identity graphs 308A using a selected graph lookup identity namespace to determine the identity values for the selected common identity namespace (e.g., EMAIL). Each event record of the event record dataset from web channel 302A and event record dataset from call center channel 306A are appended to include the identity values for the selected common identity namespace (e.g., EMAIL), thereby generating stitched event record dataset for web channel 312A and stitched event record dataset for call center channel 316A. As each of the event records from the different communication channels are appended to include a common identity (e.g., EMAIL) in stitched event record dataset for web channel 312A and stitched event record dataset for call center channel 316A, unified cross-channel reporting 314A can be generated centered on the common identity of EMAIL. For example, unified cross-channel reporting 314A include generating performance metrics and/or personalizing customer experiences across the different communication channels.

As can be understood from the example diagram 300B of FIG. 3B, profile record datasets and/or event record datasets (e.g., such as event record datasets 302B) from various communication channels can be used to determine identity graphs 304B that provide mappings of relationships between different identities.

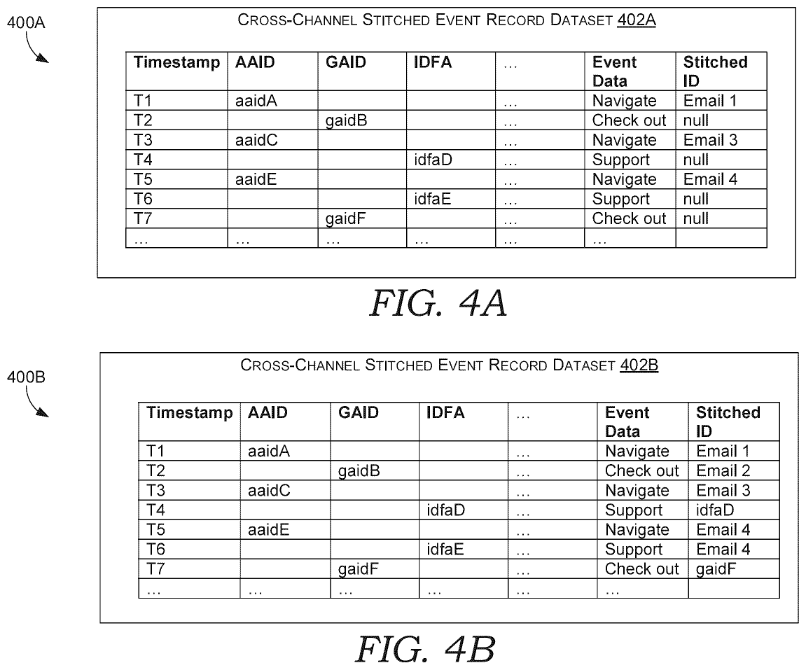

As can be understood from the example diagram 400A of FIG. 4A, the selected graph lookup identity namespace of the event record datasets (e.g., AAID) can be used to perform a graph lookup of the identity graphs 304B of FIG. 3B to determine the identity values for the selected common identity namespace (e.g., EMAIL). The event record datasets 302B of FIG. 3B can then be appended to include the common identity namespace (e.g., the stitched ID) as shown in the cross-channel stitched event record dataset 402A of FIG. 4A.

As can be understood from the example diagram 400B of FIG. 4B, a graph lookup identity namespace can be selected for each of the event record datasets (e.g., AAID for the event record dataset for communication channel A, GAID for the event record dataset for communication channel B, and IDFA for the event record dataset for communication channel C). Each of the selected graph identity lookup namespaces for each communication channel can be used to perform a graph lookup of the identity graphs 304B of FIG. 3B to determine the identity values for the selected common identity namespace (e.g., EMAIL). The event record datasets 302B of FIG. 3B can then be appended to include the common identity namespace (e.g., the stitched ID) as shown in the cross-channel stitched event record dataset 402B of FIG. 4B.

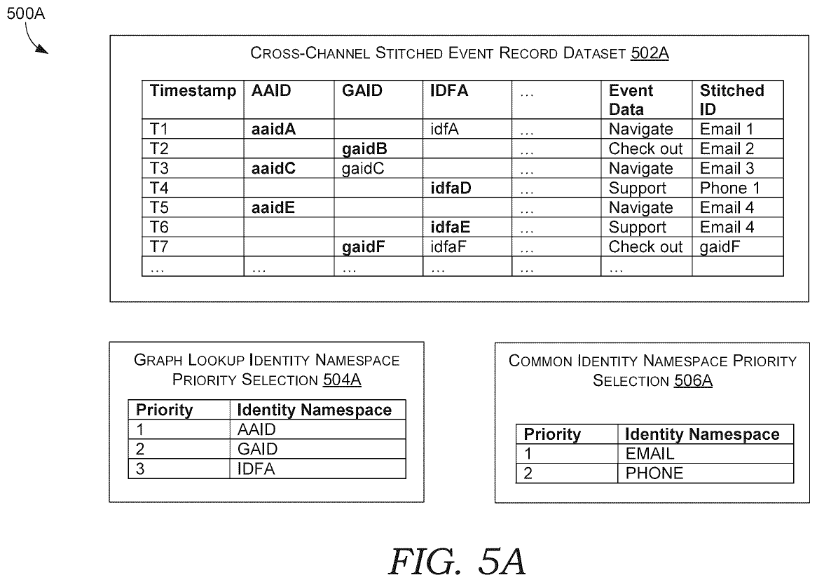

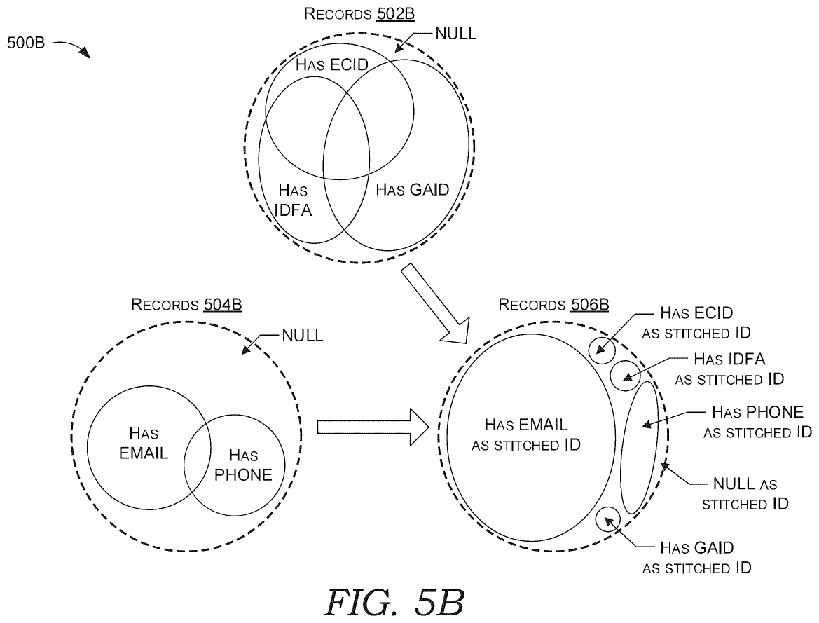

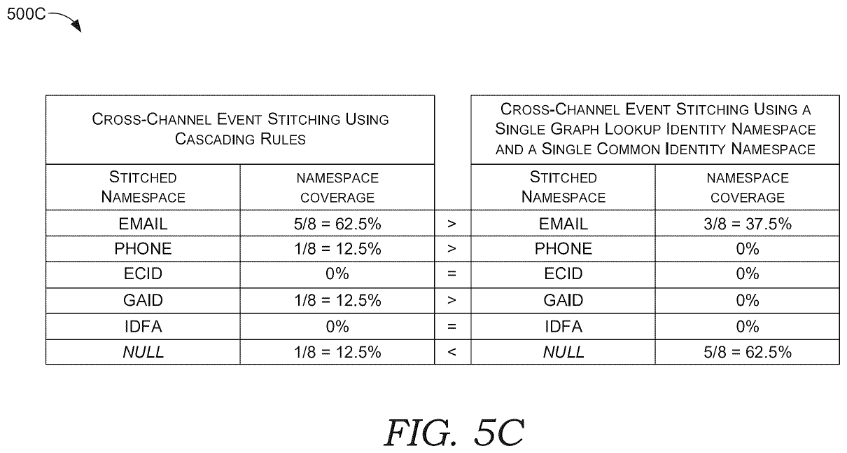

As can be understood from the example diagram 500A of FIG. 5A, a selected priority of graph lookup identity namespaces shown by graph lookup identity namespace priority selection 504A can be used to determine which identity namespace to use as the graph lookup identity namespace. As shown in the example of FIG. 5A, AAID has a higher priority than GAID, which has a higher priority than IDFA. The identity value of the highest priority graph lookup identity namespace that is available in the event record (e.g., as indicated by bold text in each event record of 502A) is then used to perform a graph lookup of the identity graphs 304B of FIG. 3B to determine the identity values for the selected priority of common identity namespaces. As shown in the example diagram 500A of FIG. 5A, the common identity namespace priority selection 506 shows that email has a higher priority than phone number. Thus, when an email address identity value is available in the identity graph, the email address identity value is set as the stitched ID. When an email address identity value is not available in the identity graph, but a phone number identity value is available in the identity graph, the phone number identity values is set as the stitched ID. When an email address identity value and the phone number identity value are not available in the identity graph, the identity value of the stitched ID is set to the identity values of the graph lookup identity namespace.

As can be understood from the example diagram 500B of FIG. 5B, cross-channel event stitching results in certain event records of the event record datasets from different communication channels being appended to include an identity value for a common identity namespace (e.g., a stitched ID) that was not previously present in the event record. Venn diagram 502B shows the amount of event records from event record datasets from different communication channels that include a corresponding identity value for each device identity namespace prior to cross-channel event stitching. For example, Venn diagram 502B indicates that, prior to cross-channel event stitching, some event records include a GAID identity value, some event records include an ECID identity value, some event records include an IDFA identity value, some event records include some combination of a GAID identity value, an IDFA identity value and an ECID identity value, and some event records do not include any GAID identity value, IDFA identity value or ECID identity value.

Venn diagram 504B shows the amount of event records from event record datasets from different communication channels that include a corresponding identity value for each user identity namespace prior to cross-channel event stitching. For example, as can be understood from Venn diagram 504B, when EMAIL is selected the common identity namespace, some event records include an EMAIL identity value, For example, Venn diagram 504B indicates that, prior to cross-channel event stitching, some event records include an EMAIL identity value, some event records include a PHONE identity value, some event records include some combination of an EMAIL identity value and a PHONE identity value, and some event records do not include any EMAIL identity value or PHONE identity value.

Venn diagram 506B shows the amount of event records from event record datasets from different communication channels that include a corresponding identity value for the common identity namespace following cross-channel event stitching. For example, Venn diagram 506B indicates that when EMAIL is selected as the common identity namespace, additional event records from the event record datasets from different communication channels are appended to include an EMAIL identity value following cross-channel event stitching in comparison to Venn diagram 504B. In this regard, the additional event records that are appended to include an EMAIL identity value can be utilized to generate performance metrics and/or personalize customer experiences across the different communication channels.

As can be further understood from Venn diagram 506B, when a selected priority of common identity namespaces is utilized instead of a single, selected common identity namespace, following cross-channel event stitching, some event records include an EMAIL identity value in the common identity namespace, some event records include a PHONE identity value in the common identity namespace, some event records include an ECID identity value in the common identity namespace, some event records include a GAID identity value in the common identity namespace, some event records include an IDFA identity value in the common identity namespace, and some event records do not include any identity value in the common identity namespace. In this regard, as the total coverage of the number of event records that include an identity value in the common identity namespace is increased, additional event records can be utilized to generate performance metrics and/or personalize customer experiences across the different communication channels.

FIG. 5C provides an example table 500C indicating the increase in coverage of the common identity namespace, in certain scenarios, when a selected priority of graph lookup identity namespaces and a selected priority of common identity namespaces is utilized (e.g., cross-channel event stitching using cascading rules) instead of a single, selected graph lookup identity namespace and a single, selected common identity namespace. In the example scenario of FIG. 5C, the percentage (e.g., the namespace coverage metric) of event records that include an EMAIL identity value in the common identity namespace is increased from 37.5% when a single, selected graph lookup identity namespace is utilized to 62.5% when a selected priority of graph lookup identity namespaces is utilized. Further, in the example scenario of FIG. 5C, the percentage of event records that do not include any identity value in the common identity namespace (e.g., NULL) is decreased from 62.5% when a single, selected graph lookup identity namespace is utilized to 12.5% when a selected priority of graph lookup identity namespaces is utilized, thereby resulting in an increase in total coverage of the common identity namespace.

Returning to FIG. 2, in certain embodiments, as each of the event records from the different communication channels are appended to include a common identity, businesses can utilize the event records to generate performance metrics, such as conversion rates, resolution rates or other metrics across the different communication channels, via analysis component 212 and/or personalize customer experiences via customer experience design component 214 across the different communication channels. In some embodiments, businesses can utilize the appended event records to build a comprehensive customer profile for the customer across the different communication channels, including demographic information, behavior data, transaction history, and/or any other customer data collected for the customer to optimize personalized and/or targeted marketing strategies via customer experience design component 214. In some embodiments, businesses can implement customer journeys to trigger actions within targeted, personalized advertising campaigns for customers based on specific interactions with the customer across the different communication channels via customer experience design component 214.

In some embodiments, a metric can be generated via analysis component 212 corresponding to a percentage of the event records of the event record datasets from different communication channels that are appended to include a corresponding detected identity value for the selected common identity namespace and/or selected priority of common identity namespaces. For example, analysis component 212 can generate a namespace coverage metric corresponding to a percentage of the event records that include a corresponding detected identity value for the selected common identity namespace and/or selected priority of common identity namespaces, such as the namespace coverage metrics provided in example table 500C of FIG. 5C

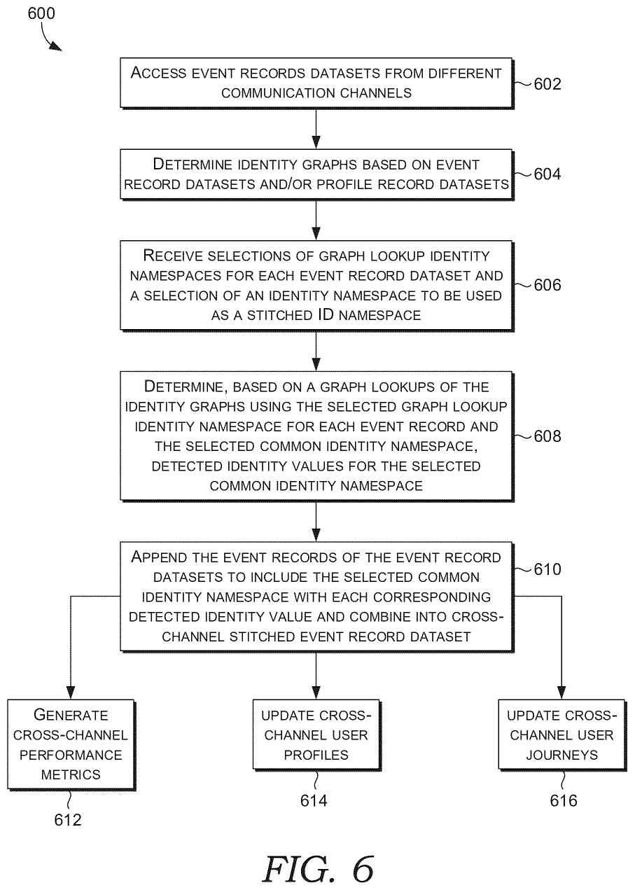

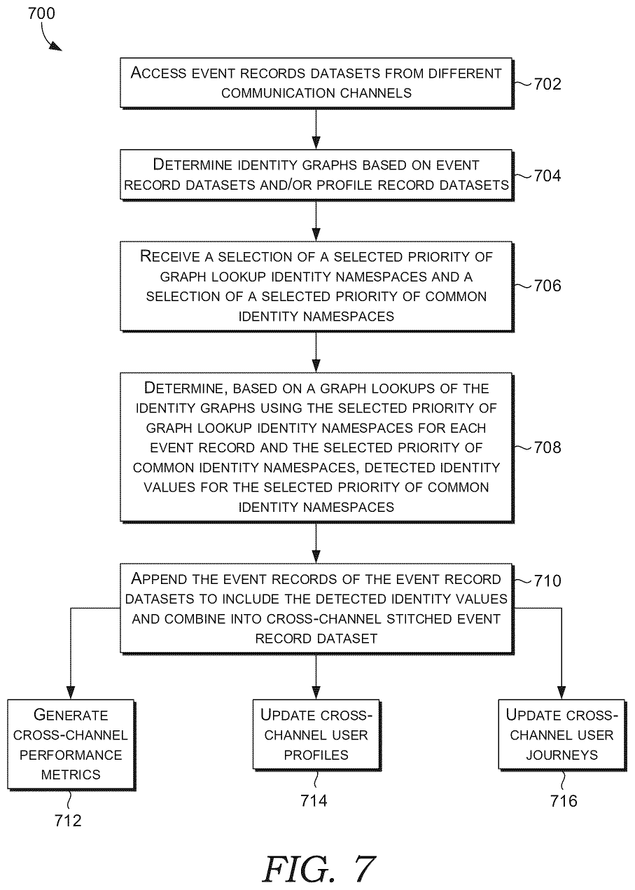

With reference now to FIGS. 6-7, FIGS. 6-7 provide method flows related to facilitating cross-channel event stitching using identity graphs, in accordance with embodiments of the present technology. Each block of method 600 and 700 comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. The method flows of FIGS. 6-7 are exemplary only and not intended to be limiting. As can be appreciated, in some embodiments, method flows 600-700 can be implemented, at least in part, to facilitate cross-channel event stitching using identity graphs.

Turning now to FIG. 6, a flow diagram 600 is provided showing an embodiment of a method 600 for cross-channel event stitching using identity graphs, in accordance with embodiments described herein. Initially, at block 602, event records datasets are accessed from different communication channels. For example, a business collects event records from various communication channels, such as web applications, mobile applications, email, SMS, social media platforms, call centers and/or other communication channels, or combinations thereof, via a corresponding event collection component for each communication channel. In some embodiments, each communication channel is further subdivided based on the platform, such as each mobile application for Apple and Google can be a separate communication channel. The event records for each communication channel are then stored in a corresponding event record dataset for each communication channel. For example, each event record dataset for each communication channel can be stored in a separate database of the corresponding communication channel. In some embodiments, the corresponding event records of a corresponding event record dataset of one communication channel includes a different combination of device identity namespaces and user identity namespaces than a different corresponding event record dataset of a different communication channel.

At block 604, identity graphs are determined based on the event record datasets and/or profile record datasets from the different communication channels. For example, identity graphs corresponding to data structures that map relationships between identities are generated based on event record datasets and/or profile record datasets from different communication channels. In some embodiments, an identity graph includes identity nodes, which represent unique identities, such as user identities and device identities, and edges, which depict the relationships or connections between identity nodes. In some embodiments, each identity node of an identity graph includes an identity namespace and an identity value and each edge can include various properties regarding the relationship between the identity nodes, such as properties related to events establishing the relationship between the identity nodes (e.g., a first established timestamp and a last updated timestamp).

At block 606, selections of graph lookup identity namespaces are received for each event record dataset and a selection of an identity namespace to be used as a stitched ID namespace is also received. In some embodiments, the selected graph lookup identity namespace is selected only from corresponding device identity namespaces and the selected common identity namespace is only selected from corresponding user identity namespaces. In some embodiments, the selected graph lookup identity namespace for each event record dataset comprises a corresponding selected device identity namespace for the corresponding event record dataset that is different than another corresponding selected device identity namespace for the different corresponding event record dataset. In some embodiments, the selected common identity namespace comprises a single corresponding selected user identity namespace for all of the event record datasets.

At block 608, detected identity values for the selected common identity namespace are determined based on a graph lookups of the identity graphs using the selected graph lookup identity namespace for each event record and the selected common identity namespace. In some embodiments, when an identity value of the selected common identity namespace is unavailable in the corresponding identity graph after performing the graph lookup, the identity value of the common identity namespace can be set to the identity value of the graph lookup identity namespace. In some embodiments, if there are multiple identity values for the same identity namespace, timestamps and/or other provided rankings of the identity values can be used to determine which identity value to use. For example, when there are multiple identity values available for the selected common identity namespace, the identity value with the most recent timestamp (e.g., which can be indicated by the edge properties in the identity graph) can be used as the identity value for the selected common identity namespace.

At block 610, the event records of the event record datasets are appended to include the selected common identity namespace with each corresponding detected identity value and the event record datasets from the different communication channels are combined into a cross-channel stitched event record dataset. In some embodiments, a corresponding event record is appended to include a corresponding detected identity value of the selected common identity namespace, wherein the different combination of device identity namespaces and user identity namespaces of the corresponding event record dataset does not include the selected common identity namespace.

As each of the event records from the different communication channels are appended to include a common identity, businesses can utilize the event records to generate performance metrics across the different communication channels, and/or personalize customer experiences across the different communication channels. For example, at block 612, cross-channel performance metrics are generated using the cross-channel stitched event record dataset. As another example, at block 614, cross-channel user profiles are updated using the cross-channel stitched event record dataset. In this regard, the event records of the cross-channel stitched event record dataset can be filtered for the particular user by the identity values of the common identity namespace associated with the particular user. The cross-channel stitched event records can then be sorted according to timestamp data and the user profile of the particular customer can then be updated. As another example, at block 616, cross-channel user journeys are updated using the cross-channel stitched event record dataset. In some embodiments, a metric can be generated corresponding to a percentage of the event records of the event record datasets from different communication channels that are appended to include a corresponding detected identity value for the selected common identity namespace.

Turning now to FIG. 7, a flow diagram 700 is provided showing an embodiment of a method 700 for cascading rules for cross-channel event stitching using identity graphs, in accordance with embodiments described herein. Initially, at block 702, event records datasets are accessed from different communication channels. At block 704, identity graphs are determined based on the event record datasets and/or profile record datasets from the different communication channels.

At block 706, a selection of a selected priority of graph lookup identity namespaces are received and a selection of a selected priority of common identity namespaces are received (e.g., identity namespace to be used as a stitched ID namespace). In some embodiments, the selected priority of graph lookup identity namespaces is selected only from corresponding device identity namespaces and the selected priority of common identity namespaces is only selected from corresponding user identity namespaces. In some embodiments, the selected priority of graph lookup identity namespaces includes a selected device identity namespace that is available in one of the event record datasets from one of the communication channels and another selected device identity namespace that is not available in the event record dataset, but available in a different one of the event record datasets from a different one of the communication channels.

At block 708, detected identity values for the selected priority of common identity namespaces are determined based on a graph lookups of the identity graphs using the selected priority of graph lookup identity namespaces for each event record and the selected priority of common identity namespaces. For example, for each event record, a corresponding device identity value for a corresponding graph lookup identity namespace with a highest priority in the selected priority of graph lookup identity namespaces and available in a corresponding event record is determined. During the graph lookup of the identity graphs, a corresponding user identity value is determined for a corresponding common identity namespace with a corresponding highest priority in the selected priority of common identity namespaces and available in a corresponding identity graph. The corresponding user identity value is determined to be a corresponding detected identity value of the detected identity values for the corresponding event record. In some embodiments, when the selected priority of common identity namespaces is unavailable in the corresponding identity graph after performing the graph lookup, the common identity namespace can be set to the identity value of the graph lookup identity namespace. In some embodiments, if there are multiple identity values for the same identity namespace, timestamps and/or other provided rankings of the identity values can be used to determine which identity value to use. For example, when there are multiple identity values available for the selected priority of common identity namespaces, the identity value with the most recent timestamp (e.g., which can be indicated by the edge properties in the identity graph) can be used as the identity value for the selected priority of common identity namespaces.

At block 710, the event records of the event record datasets are appended to include the detected identity value for each event record and the event record datasets from the different communication channels are combined into a cross-channel stitched event record dataset. In some embodiments, a corresponding event record is appended to include a corresponding detected identity value of the selected priority of common identity namespaces, wherein the different combination of device identity namespaces and user identity namespaces of the corresponding event record dataset does not include the identity namespace of the corresponding detected identity value.

As each of the event records from the different communication channels are appended to include a selected priority common identities, businesses can utilize the event records to generate performance metrics across the different communication channels, and/or personalize customer experiences across the different communication channels. For example, at block 712, cross-channel performance metrics are generated using the cross-channel stitched event record dataset. As another example, at block 714, cross-channel user profiles are updated using the cross-channel stitched event record dataset. In this regard, the event records of the cross-channel stitched event record dataset can be filtered for the particular user by the identity values of the common identity namespace associated with the particular user. The cross-channel stitched event records can then be sorted according to timestamp data and the user profile of the particular customer can then be updated. As another example, at block 716, cross-channel user journeys are updated using the cross-channel stitched event record dataset. In some embodiments, a metric can be generated corresponding to a percentage of the event records of the event record datasets from different communication channels that are appended to include a corresponding detected identity value for the selected priority of common identity namespaces.

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 8 in particular, an exemplary operating environment for implementing aspects of the technology described herein is shown and designated generally as computing device 800. Computing device 800 is just one example of a suitable computing environment and is not intended to suggest any limitation as to the scope of use or functionality of the technology described herein. Neither should the computing device 800 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 8, computing device 800 includes a bus 810 that directly or indirectly couples the following devices: memory 812, one or more processors 814, one or more presentation components 816, input/output (I/O) ports 818, I/O components 820, an illustrative power supply 822, and a radio(s) 824. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 8 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 8 and refer to “computer” or “computing device.”

Computing device 800 typically includes a variety of computer-readable media. Computer-readable media can be any available media that can be accessed by computing device 800 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 812 includes computer storage media in the form of volatile and/or nonvolatile memory. The memory 812 may be removable, non-removable, or a combination thereof. Exemplary memory includes solid-state memory, hard drives, and optical-disc drives. Computing device 800 includes one or more processors 814 that read data from various entities such as bus 810, memory 812, or I/O components 820. Presentation component(s) 816 present data indications to a user or other device. Exemplary presentation components 816 include a display device, speaker, printing component, and vibrating component. I/O port(s) 818 allow computing device 800 to be logically coupled to other devices including I/O components 820, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 814 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 800. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

A computing device may include radio(s) 824. The radio 824 transmits and receives radio communications. The computing device may be a wireless terminal adapted to receive communications and media over various wireless networks. Computing device 800 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

What is claimed is:

1. A computer-implemented method comprising:
accessing identity graphs corresponding to data structures that map relationships between identities based on at least one of event record datasets from different communication channels and profile record datasets;
accessing event records of the event record datasets, wherein a corresponding event record dataset comprises a different combination of device identity namespaces and user identity namespaces than a different corresponding event record dataset of the event record datasets;
determining detected identity values for a selected priority of common identity namespaces based on a graph lookup of the identity graphs using a selected priority of graph lookup identity namespaces and the selected priority of common identity namespaces;
appending the event records of the event record datasets to include the detected identity values; and
causing generation of performance metrics across the different communication channels based on event data and the detected identity values of the event records.

2. The computer-implemented method of claim 1, wherein the selected priority of graph lookup identity namespaces is selected only from corresponding device identity namespaces and the selected priority of common identity namespaces is only selected from corresponding user identity namespaces.

3. The computer-implemented method of claim 1, wherein the selected priority of graph lookup identity namespaces comprises a corresponding selected device identity namespace available in the corresponding event record dataset that is different than another corresponding selected device identity namespace available in the different corresponding event record dataset but unavailable in the corresponding event record dataset.

4. The computer-implemented method of claim 1, wherein determining the detected identity values for the selected priority of common identity namespaces further comprises:
for each event record of the event records:
determining a corresponding device identity value for a corresponding graph lookup identity namespace with a highest priority in the selected priority of graph lookup identity namespaces and available in a corresponding event record;
determining, based on the graph lookup of the identity graphs, a corresponding user identity value for a corresponding common identity namespace with a corresponding highest priority in the selected priority of common identity namespaces and available in a corresponding identity graph; and
determining the corresponding user identity value to be a corresponding detected identity value of the detected identity values for the corresponding event record.

5. The computer-implemented method of claim 1, wherein appending the event records of the event record datasets to include the detected identity values further comprises:
appending a corresponding event record of the corresponding event record dataset to include a corresponding detected identity value of the selected priority of common identity namespaces, wherein the different combination of device identity namespaces and user identity namespaces of the corresponding event record dataset does not include an identity namespace of the corresponding detected identity value.

6. The computer-implemented method of claim 1, wherein determining the detected identity values for the selected priority of common identity namespaces further comprises:
determining, based on the graph lookup of the identity graphs, that a user identity value for the selected priority of common identity namespaces is unavailable for a corresponding event record; and
applying a corresponding device identity value of the selected priority of graph lookup identity namespaces as a corresponding detected identity value for the corresponding event record.

7. The computer-implemented method of claim 1, further comprising:
determining corresponding event records of a particular user by:
filtering the event records of the event record datasets into a filtered set of event records based on a corresponding identity value of the particular user in the detected identity values appended to the event records; and
sorting the filtered set of event records based on timestamp data in the event data of each event record of the filtered set of event records; and
causing updating of a corresponding user profile of the particular user based on the corresponding event records of the particular user.

8. The computer-implemented method of claim 1, further comprising:
causing at least one of:
updating of user profiles across the different communication channels based on event data and the detected identity values appended to the event records; and
updating of user journeys across the different communication channels based on event data and the detected identity values appended to the event records.

9. The computer-implemented method of claim 1, further comprising:
for each of the selected priority of common identity namespaces, causing generation of a metric corresponding to a percentage of the event records of the event record datasets that are appended to include a corresponding detected identity value.

10. One or more computer-readable media having a plurality of executable instructions embodied thereon, which, when executed by one or more processors, cause the one or more processors to perform a method comprising:
accessing identity graphs corresponding to data structures that map relationships between identities based on event record datasets from different communication channels;
accessing event records of the event record datasets, wherein a corresponding event record dataset comprises a different combination of device identity namespaces and user identity namespaces than a different corresponding event record dataset of the event record datasets;
determining detected identity values for a selected priority of common identity namespaces based on a graph lookup of the identity graphs using a selected priority of graph lookup identity namespaces and the selected priority of common identity namespaces;
appending the event records of the event record datasets to include the detected identity values; and
causing updating of user profiles across the different communication channels based on event data and the detected identity values of the event records.

11. The media of claim 10, wherein the selected priority of graph lookup identity namespaces is selected only from corresponding device identity namespaces and the selected priority of common identity namespaces is only selected from corresponding user identity namespaces.

12. The media of claim 10, wherein the selected priority of graph lookup identity namespaces comprises a corresponding selected device identity namespace available in the corresponding event record dataset that is different than another corresponding selected device identity namespace available in the different corresponding event record dataset but unavailable in the corresponding event record dataset.

13. The media of claim 10, wherein determining the detected identity values for the selected priority of common identity namespaces further comprises:
for each event record of the event records:
determining a corresponding device identity value for a corresponding graph lookup identity namespace with a highest priority in the selected priority of graph lookup identity namespaces and available in a corresponding event record;
determining, based on the graph lookup of the identity graphs, a corresponding user identity value for a corresponding common identity namespace with a corresponding highest priority in the selected priority of common identity namespaces and available in a corresponding identity graph; and
determining the corresponding user identity value to be a corresponding detected identity value of the detected identity values for the corresponding event record.

14. The media of claim 10, wherein appending the event records of the event record datasets to include the detected identity values further comprises:
appending a corresponding event record of the corresponding event record dataset to include a corresponding detected identity value of the selected priority of common identity namespaces, wherein the different combination of device identity namespaces and user identity namespaces of the corresponding event record dataset does not include an identity namespace of the corresponding detected identity value.

15. The media of claim 10, wherein determining the detected identity values for the selected priority of common identity namespaces further comprises:
determining, based on the graph lookup of the identity graphs, that a user identity value for the selected priority of common identity namespaces is unavailable for a corresponding event record; and
applying a corresponding device identity value of the selected priority of graph lookup identity namespaces as a corresponding detected identity value for the corresponding event record.

16. The media of claim 10, further comprising:
determining corresponding event records of a particular user by:
filtering the event records of the event record datasets into a filtered set of event records based on a corresponding identity value of the particular user in the detected identity values appended to the event records; and
sorting the filtered set of event records based on timestamp data in the event data of each event record of the filtered set of event records; and
causing updating of a corresponding user profile of the particular user based on the corresponding event records of the particular user.

17. The media of claim 10, further comprising:
causing at least one of:
generating of performance metrics across the different communication channels based on the updated user profiles; and
updating of user journeys across the different communication channels based on the updated user profiles.

18. A computing system comprising:
a processor; and
a non-transitory computer-readable medium having stored thereon instructions that when executed by the processor, cause the processor to perform operations including:
accessing identity graphs corresponding to data structures that map relationships between identities based on event record datasets from different communication channels;
accessing event records of the event record datasets, wherein a corresponding event record dataset comprises a different combination of device identity namespaces and user identity namespaces than a different corresponding event record dataset of the event record datasets;
determining detected identity values for a selected priority of common identity namespaces based on a graph lookup of the identity graphs using a selected priority of graph lookup identity namespaces and the selected priority of common identity namespaces;
appending the event records of the event record datasets to include the detected identity values; and
causing updating of user journeys across the different communication channels based on event data and the detected identity values of the event records.

19. The system of claim 18, wherein the selected priority of graph lookup identity namespaces comprises a corresponding selected device identity namespace available in the corresponding event record dataset that is different than another corresponding selected device identity namespace available in the different corresponding event record dataset but unavailable in the corresponding event record dataset.

20. The system of claim 18, wherein determining the detected identity values for the selected priority of common identity namespaces further comprises:
for each event record of the event records:
determining a corresponding device identity value for a corresponding graph lookup identity namespace with a highest priority in the selected priority of graph lookup identity namespaces and available in a corresponding event record;
determining, based on the graph lookup of the identity graphs, a corresponding user identity value for a corresponding common identity namespace with a corresponding highest priority in the selected priority of common identity namespaces and available in a corresponding identity graph; and
determining the corresponding user identity value to be a corresponding detected identity value of the detected identity values for the corresponding event record.
